(19) United States
(12) Patent Application Publication
(10) Pub. No.: US 2014/0038160 A1
(43) Pub. Date: Feb. 6, 2014

(54) PROVIDING COMPUTER AIDED SPEECH AND LANGUAGE THERAPY

(71) Applicants: Mordechai Shani, Ramat-Efal (IL); Yoram Feldman, Tel Mond (IL)

(72) Inventors: Mordechai Shani, Ramat-Efal (IL); Yoram Feldman, Tel Mond (IL)

(21) Appl. No.: 14/110,193

(22) PCT Filed: Apr. 3, 2012
(86) PCT No.: PCT/IB12/51624

§ 371 Date: Oct. 22, 2013

Related U.S. Application Data
(60) Provisional application No. 61/472,650, filed on Apr. 7, 2011.

(51) Int. Cl. G09B 7/06

(52) U.S. Cl. CPC G09B 7/06
USPC 434/353

(57) ABSTRACT

A system for providing computer-aided speech and language therapy is provided herein. The system includes: a user interface configured to provide a language or a speech exercise to a patient, over a computer terminal wherein the exercise comprises at least one non multiple choice question; an analyzer configured to analyze performance of the exercise as carried out by the client, to determined a type of error, in a case of an error by the patient; and a guidance generator configured to generate a guidance instructing the patient to a correct answer to the provided exercise, wherein the guidance is generated based, at least partially, on the type of error made by the patient, wherein analyzer and the guidance generator are further configured to repeatedly analyze and generate guidance in further attempts of the patient to perform the exercise.

### BACKGROUND

1. Technical Field

The present invention relates to providing computer aided speech and language therapy and more specifically, to providing such therapy over a computer network and managing thereof.

2. Discussion of the Related Art

Depending on the area and extent of brain damage, someone suffering from aphasia may be able to speak but not write, or vice versa, or display any of a wide variety of other deficiencies in language comprehension and production, such as being able to sing but not speak. For clarity, as used herein aphasia means both partial and total language impairment. Aphasia may co-occur with speech disorders such as dysarthria or apraxia of speech, which also result from brain damage. Aphasia can be assessed in a variety of ways, from quick clinical screening at the bedside to several-hour-long batteries of tasks that examine the key components of language and communication. The prognosis of those with aphasia varies widely, and is dependent upon age of the patient, site and size of lesion, and type of aphasia.

Computer aided systems directed to address the aforementioned speech and language deficiencies are known in the art. An exemplary prior art system includes speech input, speech recognition and natural language understanding, and audio and visual outputs configured to enable an aphasic patient to conduct self-paced speech therapy autonomously. The exemplary prior art system conducts a therapy exercise by displaying a picture; generating a speech prompt asking the patient for information about the picture; receiving the patient's speech response and processing it to determine its semantic content; determining whether the patient's response was correct; and outputting feedback to the patient. Preferably the system includes a touch screen as a graphical input/output device by which the patient controls the therapy exercise.

### BRIEF SUMMARY

One aspect of the present invention discloses a system for providing computer-aided speech and language therapy. The system includes the following components: a user interfaces configured to provide a language or a speech exercise to respective patients, over a computer terminal, wherein the exercise comprises at least one non multiple choice question; an analyzer configured to analyze performance of the exercise as carried out by the client, by using a set of interconnected dictionaries, to determined a type of error, in a case of an error by the patient; and a guidance generator configured to generate a guidance instructing the patient to the correct answer to the provided exercise, wherein the guidance is generated based, at least partially, on the type of error made by the patient, wherein the analyzer and the guidance generator are further configured to repeatedly analyze and generate guidance in further attempts of the patient to perform the exercise, and wherein the system refers the patient to a human expert after a predefined number of failed attempts. Another aspect of the present invention discloses a method of providing computer-aided speech and language therapy. The method may include the following stages: providing a language or a speech exercise to a patient, over a computer terminal, wherein the exercise is non-indicative of potential correct answers; analyzing performance of the exercise as expressed in an attempt of the client to respond to the exercise, to yield a type of error, in a case of an error; generating a guidance instructing the patient to a correct answer to the provided exercise, wherein the guidance is generated based, at least partially, on the type of error made by the patient; repeating the analyzing and the generating in further attempts of the patient to perform the exercise; and referring the patient to a human expert after a predefined number of failed attempts.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating an exemplary system according to some embodiments of the invention;

FIG. 2 is a high level schematic block diagram illustrating an aspect according to some embodiments of the invention;

FIG. 3 shows a high level flowchart illustrating a method according to some embodiments of the invention;

FIG. 4 shows a diagram illustrating an aspect of the user interface according to some embodiments of the invention;

FIG. 5 shows a diagram illustrating another aspect of the user interface according to some embodiments of the invention; and

FIG. 6 shows a diagram illustrating yet another aspect of the user interface according to some embodiments of the invention.

The drawings together with the following detailed description make apparent to those skilled in the art how the invention may be embodied in practice.

### DETAILED DESCRIPTION

Prior to setting forth the detailed description, it may be helpful to set forth definitions of certain terms that will be used hereinafter.

The term “speech exercise” or “language exercise” as used herein refers to a question associated with a physical item displayed visually to a patient who suffers from a speech or language related disability. The exercises referred to in this disclosure do not provide or present potential correct answers. Specifically, they are not in a multiple choice form. The patient has to recognize the item and to provide an answer to questions that are contextually associated with the displayed item.

The term “guidance” or “guiding gesture” as used herein refers to further information or an instructing phrase that is supposed and meant to direct the patient to the correct answer of a given exercise.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

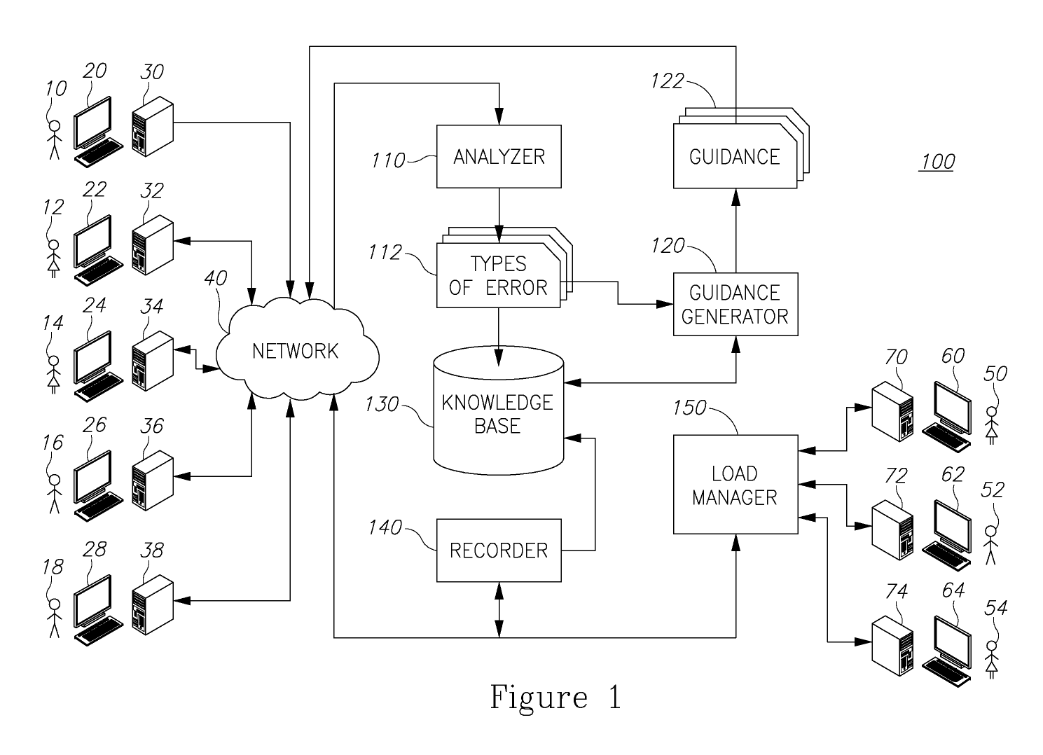

FIG. 1 is a high level schematic block diagram illustrating a system according to some embodiments of the invention. System 100 may be implemented over a computer network 40 in a client server configuration. It is understood however, that the present invention may be also practiced in a case of a single patient and a single computer terminal and not in a client-server configuration. Each one of patients 10-18 is provided with his or her respective user interface 20-28 (usually a display, a keyboard and a microphone-speaker set). Each one of user interface 20-28 is connected via its respective computer 30-38 to computer network 40. It is understood that user interfaces 20-28 need not necessarily be associated with standard personal computers and may be implemented by cellular communication devices such as smart phones and the like.

System 100 is configured to provide, usually from a central location (i.e., the server) to a plurality of patients 10-18 via network 40 language and/or speech exercises that are presented to them over user interfaces 20-28 (i.e., the clients). These exercises are non-indicative of the potential correct answer (and are not in the form of a multiple choice quiz). Each one of patients 10-18 receives a tailored exercise that meets his or her needs and abilities. The exercises are being updated over the sessions based on the analyzed performance of patients 10-18. In order to achieve that, System 100 includes an analyzer 110 configured to analyze performance of the exercises as they are being carried out by patients 10-18 who provide their responses to the exercises via user interfaces 20-28. The analysis of analyzer 110 yields for each one of patients 10-18 a respective type of error 112 associated with a specific exercise (in case the patient made an error). In response to such an error, system 100 automatically issues guidance to the patient that imitates a guidance made by a human expert such as a communication therapist. System 100 further includes guidance generator 120 configured to generate a guidance 122 instructing the patient to a correct answer to the provided exercise. Guidance 122 may be in the form of typed text but can also be in the form of a synthetic voice using a text-to-voice module or video or animated video avatar. Guidance 122 is generated based, at least partially, on the type of error 112 made by the patient as analyzed and determined by analyzer 110. Upon generating of guidance 122 it is presented to the respective patient who carried out the exercise and who made the specific error.

Throughout a treatment session, analyzer 110 and the guidance generator 120 are further configured to repeatedly analyze a plurality of exercises and generate a plurality of respective guidance in further attempts of the patient to perform the exercises. Additionally, in any case that a patient is involved in a predefined number of failed attempts to carry out a specific exercise or a series of exercises, that patient is referred to a human expert who then provides a human intervention to the otherwise automatic computer generated treatment session.

Analyzer 110 in cooperation with knowledge base may implement a so-called personalization of the error. In other words, for a specified A-type patient, a specified A-type error might be indicative of an A-type problem with client A-type. Thus, a B-type error for a B-type patient might mean a problem of a B-type (and not an A-type for example).

In another embodiment, system 100 may operate in a reports-only mode in which no human experts are involved. The system is fully automated without human intervention. The system analyzes the quality of the automatic treatment and issues reports as to the quality of the guidance provided by the system. The reports-only mode enables to assess the ability of the system to provide speech and lingual therapy on its own.

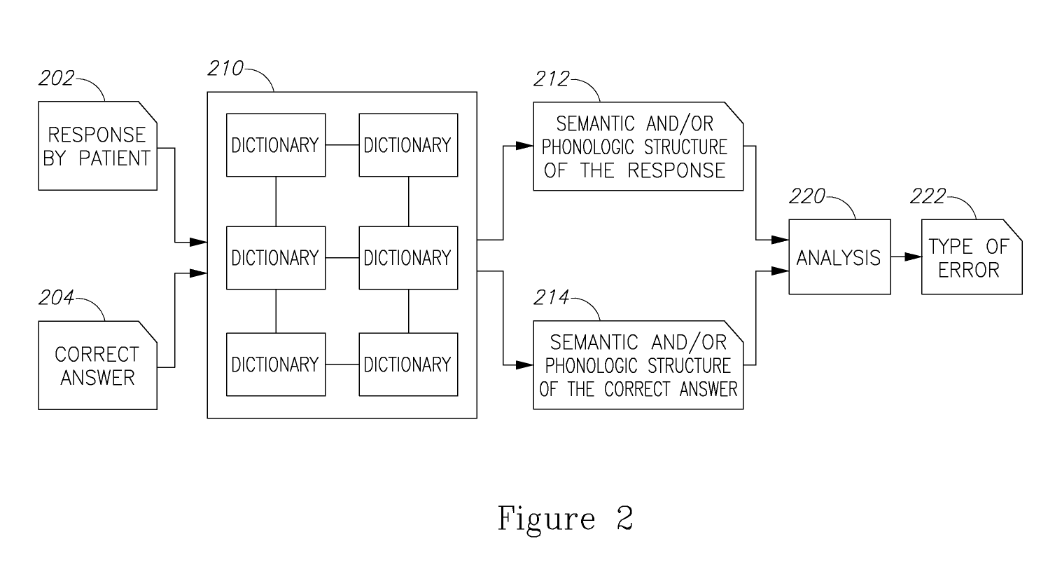

FIG. 2 is a high level schematic block diagram illustrating an aspect according to some embodiments of the invention. In some exemplary embodiments analyzer 110 may be implemented using a set of interconnected dictionaries 210 that are phonologically and semantically interconnected between them. Set of dictionaries 210 are fed with a response by the patient 202 and by a correct answer 204 to any given exercise from a predefined database. Set of dictionaries 210 is then used to generate a respective semantic and/or phonologic structure of the response 212 and a respective semantic and/or phonologic structure of the correct answer 214. These semantic structures are analyzed in an analysis process 220 that may involve comparison under a same semantic model. The analysis yields a respective type of error 222 for each response, given any pair of exercise-correct answer. Types of error 222 are then ordered and classified into predefined classes that allow reusability whenever future responses are recognized as associated with an already classified type of error. Similarly, analyzer 110 may also be configured to carry out a phonologic analysis in order to determine a type of phonologic errors. In analyzing phonologic error, instead of dictionaries, analyzer 110 may use a phonologic model which is used to map the response and the correct answer to a single phonologic space and to determine, based on the distance between them within the phonologic space, the exact type of phonologic error to be used later by guidance generator 120.

As explained above, the guidance is tailored by guidance generator 120 based on the detected type of error so that the most suitable feedback will be provided to the patient. The following description relates to several types of error and how the appropriate guidance is determined:

In a guidance provided in response to a phonologic error for an exercise that does not include a multiple choice answer some of the following features may be used: marking a missing letter, marking an extra letter, indicating letters misplacement, indicating letters reordering, indicating a specific typo, and the like. The guidance would state what is wrong with the answer while guiding the patient to what should be correct answer.

In a guidance provided in response to a semantic error for an exercise that does not include a multiple choice answer some of the following features may be used: indication that the context is correct but the word is wrong, an indication on the class of that object, providing a functional guidance—what operation is carried out in conjunction with that object, referring the patient to his own immediate environment and to the presence of such an object.

In case of a failure of the patient to provide the correct answer after receiving a semantic or phonologic guidance, a further guidance is presented which takes into account the additional errors made by the patients. By monitoring the reoccurring attempts, it would be possible to further learn the nature of errors and deduce from them a more accurate diagnosis of the patient so that better guidance would be provided to the patient and more appropriate exercise would be presented in the future.

In some embodiments, the guidance may be provided by way of suggestion by guidance generator 120 to the human expert who in turn decides upon the exercise or the guidance. Alternatively, guidance generator 120 provides both exercises and guidance automatically while the human expert is merely notified only after reoccurring failures of the patients to accomplish the language or speech exercises.

Following are several types of errors that may be determined by analyzer 110 and used in order to generate the most appropriate guidance. One type of error is an error in the meaning of the word—these semantic mistakes are of a contextual nature—the word is mistakenly replaced with another word of a neighboring meaning. Another type of error is a phonologic error in which syllables are being replaced, added, or omitted so that a meaningless word is created. An exception may be a formal mistake that creates a word with a different meaning. Yet another type of error is an unrelated word being neither semantic nor phonologic mistake. This creates a word that has a meaning which is totally unrelated to the correct word. Yet another type of mistake is a visual mistake that stems from a visual similarity between two different objects which may lead to confusion in the words representing them.

Following is a non-limiting exemplary flow of the process of determining the type of error by analyzer 110 once a patient provides a specific word as an answer to a language or a speech exercise by comparing to the correct word: (i) checking whether the specified word is a real word, using a database and/or dictionaries; (ii) comparing phonologic characteristics by comparing to the correct word (a phonologic error may be combined with a semantic error); (iii) comparing semantic-associative characteristics by measuring a distance between the correct word and the specified word in the semantic-associative space; (iv) comparing morphologic characteristics; and (v) checking in an errors database deriving reoccurring errors of same patient.

In order to achieve good results, each one of the aforementioned steps needs to be carried out for each error and so even a phonologic error is detected; there is still a need to check whether a semantic error is also present.

Following are some guidelines for detecting a phonologic error by analyzer 110: letter recognition—whenever two or more letters of the specified word are recognized, the error should be regarded as a phonologic error. Correctly recognized first letter infers a phonologic error and so does a correctly recognized last letter, though to a lesser extent. Recognizing the root letters of the word is also indicative of a phonologic error. Whenever less than two letters are correctly recognized, a single letter in the correct position may still infer a remote phonologic error. A sequence of two or more correctly recognized letter increases the likelihood of a phonologic error and so does a specified phonologic pattern.

Following are some guidelines for detecting a semantic error by analyzer 110: once a word that exists in the dictionaries and yet not the correct word is detected, a phonologic resemblance is checked to rule off a phonologic error. Then, a common semantic class is checked and compared. The, synonyms and opposite words are checked. Additionally, associations are checked and so are words of various meanings, based on dictionaries.

Referring back to FIG. 1, system 100 may further include a knowledge base 130 preferably in the form of an updatable repository that is dynamically updated over therapy sessions. Types of error 112 are being paired with potential guidance 122 and so once a specific type of error 112 is detected, its respective paired guidance 122 is being presented to the patient who is carried out the exercise.

Errors analysis and accumulation may be carried out effectively using a knowledge base 130 so that errors may be retrieved later on whenever a similar error is made by the patient. In knowledgebase base 130, several error databases may be stored, for example: (i) a personal error database responsive to a specific exercise or word; (ii) a personal error database of the errors characteristics that a specified patient made generally for a variety of exercises; (iii) a general error database of errors made by the plurality of patients for a specified word.

The nature of error-related data stored on knowledge base 130 may be both qualitative and quantitative. In qualitative data the nature of the error is indicated—semantic, phonologic, unrelated and subclasses as explained above. In quantitative data, several metrics are measured such as, the errors ratio, the number of attempts of answering the exercises, the reoccurrences of the errors, number of successful attempts without intervention, time periods prior to answering the exercises and the like. The quantitative data combined with the qualitative data are used in generating reports on the advancement of the patient throughout the language and speech therapy sessions.

Knowledge base 130 may be based on classified words wherein the classification may be based, by way of example, on the following classes: (i) grammatical class (noun, verb, adjective, and the like); (ii) type of word (content, function, relation); (iii) frequency; (iv) imageability; (v) semantic; (vi) associative; (vii) phonologic; (viii) morphologic; (ix) metric (number of syllables, stress); (x) gender; (xi) orthographic; (xii) visual, and more.

Consistent with some embodiments of the present invention, knowledge base 130 may further store profiles of each one of patients 10-18 registered within system 100. Then, upon analyzing the performance of a specific patient, its respective profile is also being used in the analysis. Additionally, guidance generator 120 may be further configured to generate guidance 122 further based on the previously derived profile of the patient which is indicative of his or her language or speech abnormalities.

Consistent with some embodiments of the present invention, guidance 122 are generated by guidance generator 120 such that they are semantically and or phonologically structured so that they resemble in their structure, a guidance made by a human expert, given the type of error associated with the exercise made

Consistent with some embodiments of the present invention, system 100 may further includes an exercise generator 160 configured to generate a language or a speech exercise that is tailored to a profile of the patient indicative of his or her language or speech abnormalities. The exercises are generated automatically so that they address the specific deficiencies and difficulties from which a specific patient suffers. This way, any speech or language session starts off with an exercise that is near the upper boundary of the ability of that patient.

Consistent with some embodiments of the present invention, system 100 further includes a recorder 140 in communication with network 40 and knowledge base 130. Recorder 140 is configured to: (i) record a sequence of attempts and guidance over time and (ii) analyze the sequence to create a profile of the patient indicative of his or her language or speech abnormalities. The profile is then stored on knowledge base 130 and used as explained above in analyzing errors and in generating guidance. Additionally, Recorder 140 is configured to record a sequence of attempts and guidance over time and analyze the sequence to assess an improvement in carrying out the attempts. The assessment of the improvement may be also used by exercise generator 160 in generating exercises with a higher degree of difficulty to the patient. Similarly, guidance generator 120 is further configured to generate guidance 122 to the language or speech exercise further based on the assessed improvement in carrying out the attempts, so that guidance 122 are dynamically adjusted over the treatment session so they are more effective.

Consistent with some embodiments of the present invention, in case of a referral to human experts 50-54, the guidance provided by human experts 50-54 are being monitored, possibly by recorder 140 and more pairs of type of errors and respective guidance made are updated onto knowledge base 130 accordingly. Then, in future exercises, the recorded hits made by human experts 50-54 may be used automatically by guidance generator 120.

Consistent with some embodiments of the present invention, system 100 operate in a broadcast configuration so that a relatively small number of human experts 50-54 are in charge of a significantly larger number of patients 10-18. Advantageously, embodiments of the present invention enable a small number of speech therapists to provide therapeutic sessions to a large number of patients without compromising quality of treatment. In order to maintain a specific level of quality, recorder 140 may be further configured to monitor quality of the guidance by analyzing responsiveness of patients to computer generated guidance compared with guidance made by the human experts for similar exercises and patients with similar profiles. This quality assurance process is further facilitated by including a load manager 150 in system 100 that is connected to expert terminals 70-74 and to computer network 40. Load manager 150 is configured to allocate more human experts whenever the quality of the guidance decreases below a predefined level.

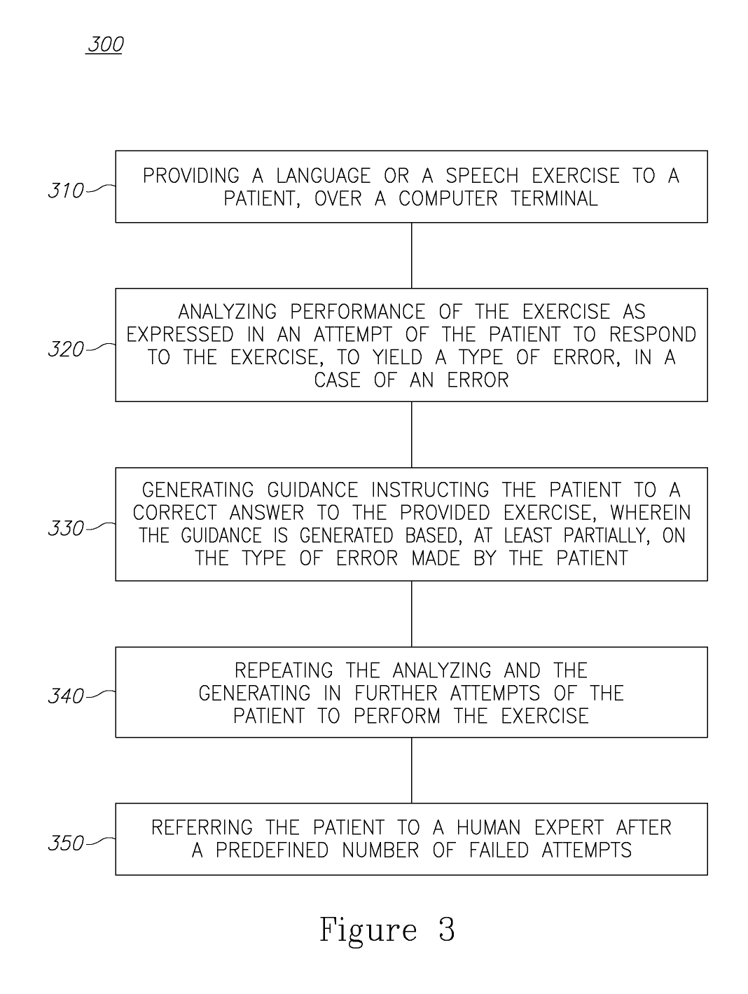

FIG. 3 shows a high level flowchart illustrating a method 300 according to some embodiments of the invention. Method 300 is not necessarily implemented by the aforementioned architecture of system 100 and may be implemented over any computer network, preferably but not necessarily in a server-client configuration as discussed above. Method 300 starts off with the stage of providing a language or a speech exercise to a patient, over a remote computer terminal via a computer network 310. The method proceeds with the stage of analyzing performance of the exercise as carried out by the patient, in order to determine the type of error, he or she made in a case of an error 320. After the analysis, the method goes on to the stage of generating a guidance instructing the patient to a correct answer to the provided exercise, wherein the guidance is generated based, at least partially, on the type of error made by the patient 330. Then the method goes on by repeating the analyzing and the generating stages in further attempts of the patient to perform the exercise 340. Finally, in a case of a predefined number of failed attempts the method goes on to the stage of referring the patient to a human expert who provides human intervention in the otherwise automatic treatment session 350.

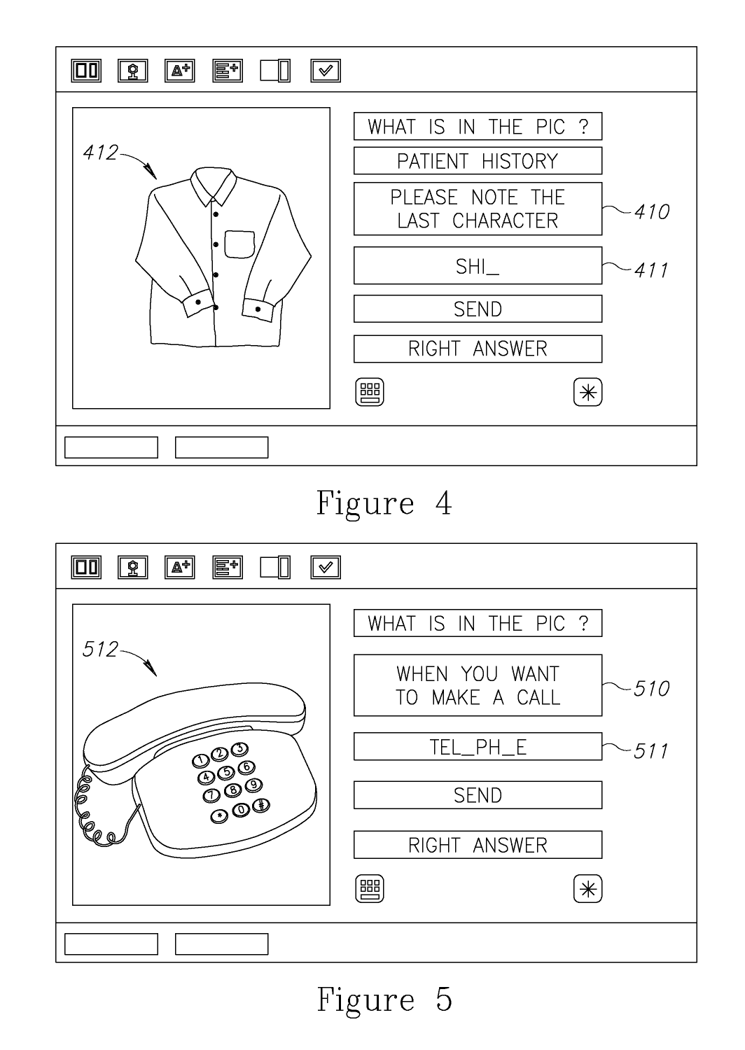

FIG. 4 shows a diagram illustrating an aspect of the user interface according to some embodiments of the invention. Screen 400 shows an item 410 (shirt) and a question related to it 420. The user is required to enter the correct answer in a specified field 430. Upon doing so, if the answer is incorrect, a guidance is generated and displayed in a specified field and relates to the specific type of error—in this case, the spelling of the last letter was wrong and so attention was drawn in the guidance to the last letter.

FIG. 5 shows a diagram illustrating another aspect of the user interface according to some embodiments of the invention. Screen 500 shows an item 510 (telephone) and a question related to it 520. The user is required to enter the correct answer in a specified field 530. Upon doing so, if the answer is incorrect, a guidance is generated and displayed in a specified field and relates to the specific type of error—in this case, the guidance explains what need the items addresses in real life (e.g. “it's something you wear”).

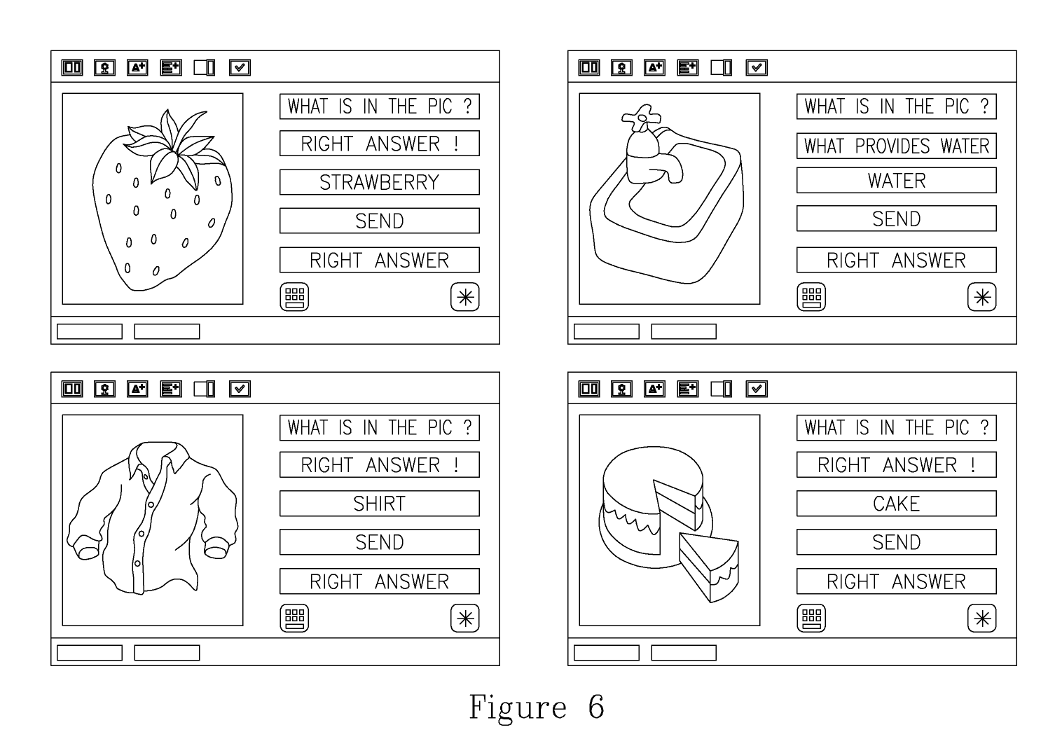

FIG. 6 shows a diagram illustrating yet another aspect of the user interface according to some embodiments of the invention. Screen 600 shows what a human expert may see when he or she manages a session with a plurality of patients (e.g., four different patients). This is achieved by showing the human expert what each one of his patients sees 610A-610D as an exercise together with the correct answer 620A-620D and what the patient actually answers 6310A-630D. Additionally, the human expert may be provided with some information relating to the profile of each one of the patients 640A-640D. When the system detect errors beyond a specified level (of the patient) or when the human experts detects too many inefficient guidance, he or she can intervene by taking over the automatic session and providing his or her own expertise for a session that is otherwise automatic.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, C# or the like and conventional procedural programming languages, such as the “C” programming language or any other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention.

1. A method comprising:
providing a language or a speech exercise to a patient, via a computer terminal, wherein the exercise comprises at least one non multiple choice question; analyzing an answer to the exercise as carried out by the patient, to determine a type of error made by patient, in a case of an error; and
generating a guidance instructing the patient to provide a correct answer to the provided exercise, wherein the guidance is generated based, at least partially, on the determined type of error.

2. The method according to claim 1, further comprising repeating the analyzing and the generating in further attempts of the patient to perform the exercise; and referring the patient to a human expert in a case of an undetermined type of error or predefined number of failed attempts.

3. The method according to claim 1, wherein the providing is carried out via remote computer terminals and over a computer network.

4. The method according to claim 1, wherein the analyzing further comprises semantic analysis that is carried out by:
(i) applying a set of logically interconnected dictionaries to the patient answer and to the correct answer, to yield respective semantic and/or phonologic relationship between the patient answer and the correct answer under a same semantic model; and
(ii) (ii) comparing the semantic structures of the patient answer and the correct answer so as to classify a type of semantic error.

5. The method according to claim 1, wherein the analyzing further comprises a phonologic analysis.

6. The method according to claim 1, wherein the generating of the guidance is further based on a knowledge base that is dynamically updated over therapy sessions.

7. The method according to claim 1, wherein the generating of the guidance is further based on a previously derived profile of the patient indicative of his or her language or speech abnormalities.

8. The method according to claim 1, wherein the guidance is such structured so that it resembles in its semantics, a guidance made by a human expert, given the type of error.

9. The method according to claim 1, further comprising generating a language or a speech exercise that is tailored to a profile of the patient indicative of his or her language or speech abnormalities.

10. The method according to claim 1, further comprising recording a sequence of attempts and guidance over time and analyzing the sequence to create a profile of the patient indicative of his or her language or speech abnormalities.

11. The method according to claim 1, further comprising recording a sequence of attempts and guidance over time and analyzing the best clinical sequence to improve the patient attempts.

12. The method according to claim 9, wherein the generating of the language or speech exercise or the generating of the guidance is further based on the profile.

13. The method according to claim 10, wherein the generating of the language or speech exercise or the generating of the guidance is further adjusted dynamically over a therapy session, based on the assessed improvement in carrying out the attempts.

14. The method according to claim 5, wherein in a case of a predefined number of failed attempts and referring of the patient to a human expert, the method further comprises monitoring guidance made by the human expert and updating the knowledge base accordingly.

15. The method according to claim 1, wherein the providing, the analyzing, and the generating are repeated and executed for a plurality of patients and one or more human experts.

16. The method according to claim 15, further comprising monitoring quality of guidance by analyzing responsiveness of patients to computer generated guidance compared with guidance made by the human experts for similar exercises and patients with similar profile.

17. The method according to claim 15, further comprising allocating more human experts whenever the quality of the guidance decreases below a predefined level.

18. A system comprising:
one or more user interfaces configured each to provide a language or a speech exercise to a respective patient, via a remote computer terminal, wherein the exercise comprises at least one non multiple choice question;
an analyzer configured to analyze performance of the exercise as carried out by the patient, to determine a type of error, in a case of an error; and
a guidance generator configured to generate a guidance instructing the patient to provide a correct answer to the provided exercise, wherein the guidance is generated based, at least partially, on the determined type of error.

19. The system according to claim 18, wherein the analyzer and the guidance generator are further configured to repeatedly analyze and generate guidance in further attempts of the patient to perform the exercise, and wherein the system refers the patient to a human in a case a predefined number of failed attempts occur.

20. The system according to claim 19, further comprising a computer network and a plurality of remote computer terminals through which the one or more user interfaces are presented to a plurality of patients.

21-36. (canceled)
